(19) United States
(12) Patent Application Publication
(10) Pub. No.: US 2007/0043548 A1
(43) Pub. Date: Feb. 22, 2007

(54) Verifying a simulated hardware environment for a simulated device under test

(75) Inventors: Abraham Arevalo, Shakopee, MN (US); Robert C. Dixon, Austin, TX (US); Alan G. Singletary, Austin, TX (US)

Correspondence Address: IBM (ROC-BLF), C/O BIGGERS & OHANIAN, LLP, P.O. BOX 1469, AUSTIN, TX, 78767-1469, US

(73) Assignee: International Business Machines Corporation, Armonk, NY (US)

(21) Appl. No.: 11/193,820

(22) Filed: Jul. 29, 2005

(51) Int. Cl. G06F 17/50

(52) U.S. Cl. 703/14

(57) ABSTRACT

Methods, apparatus, and computer program products are described for verifying a simulated hardware environment for a simulated device under test (‘DUT’) that include recording, in a software domain, interface signals between the simulated DUT and a simulated hardware device of the simulated hardware environment, the interface signals also including simulated stimulus interface signals and simulated response interface signals; exporting, from the software domain to a playback device of a hardware domain, the recorded interface signals, including the simulated stimulus interface signals and the simulated response interface signals; and playing the exported, recorded simulated stimulus interface signals in the hardware domain from the playback device to the hardware device. In typical embodiments, the hardware device in the hardware domain also including an actual hardware part operating under actual conditions of voltage, frequency, and temperature.

### BACKGROUND OF THE INVENTION

1. Field of the Invention

The field of the invention is data processing, or, more specifically, methods, apparatus, and products for verifying a simulated hardware environment for a simulated device under test (‘DUT’).

2. Description Of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

A ‘system-on-a-chip’ (‘SOC’) is a technique of integrating all components of a computer system into a single chip. An SOC may contain digital, analog, mixed-signal, and radio-frequency functions“all on one chip. A typical computer system consists of a number of integrated circuits that perform different tasks. Examples of such integrated circuits include microprocessors, memory (RAM, ROM), UARTs, parallel ports, DMA controller chips, and so on. Recent improvements in semiconductor technology have allowed VLSI integrated circuits to grow in complexity, making it possible to integrate all components of a system in a single chip. This can be done in a number of technologies including, for example, full-custom development, standard cell architectures, and field programmable gate arrays (‘FPGAs’), and complex programmable logic arrays (‘CPLAs’). SOC designs typically consume less power, cost less, and are more reliable than multi-chip systems. And with fewer packages in a system, assembly costs are reduced as well.

A typical application for an SOC is an ‘embedded system.’ An embedded system is a special-purpose computer system, which is completely encapsulated by the device it controls. An embedded system has specific requirements and performs pre-defined tasks, unlike a general-purpose personal computer.

Examples of embedded systems include:
automatic teller machines (‘ATMs’);
cellular telephones and telephone switches;
computer network equipment, routers, timeservers and firewalls;
computer printers;
copiers;
floppy disk drives, hard disk drives, CD ROM drives, DVD ROM drives;
engine controllers and antilock brake controllers for automobiles;
home automation products, thermostats, air conditioners, sprinklers, security monitoring systems;
handheld calculators;
household appliances, microwave ovens, washing machines, television sets, DVD players/recorders;
inertial guidance systems, flight control hardware/software and other integrated systems in aircraft and missiles;
medical equipment;
measurement equipment such as digital storage oscilloscopes, logic analyzers, and spectrum analyzers;
multifunction wristwatches;
multifunctional printers (‘MFPs’);
personal digital assistants (‘PDAs’), small handheld computers with personal information managers (‘PIMs’) and other applications;
mobile phones with additional capabilities, for example, mobile digital assistants with cell phone, PDA functions, and Java capabilities;
programmable logic controllers (‘PLCs’) for industrial automation and monitoring;
stationary videogame consoles and handheld game consoles; and
wearable computers.

In designing SOC devices, it is common to perform extensive simulation to verify a design's correctness before producing first prototypes. This simulation includes the design under test (‘DUT’) and a surrounding environment (sometimes called a ‘simulation environment’ or ‘test bench’) which simulates as closely as possible the conditions in which the actual SOC will operate. If an SOC will have connections to external devices, such as memories, busses or communication channels, these devices are commonly represented in the simulation by models written in a hardware description language (‘HDL’) such as VHDL or Verilog. These models may be representative of a single vendor implementation of the device or may be a generic model of some defined bus. As such, they may not reliably represent the actual behavior of the devices to which the SOC will eventually be attached. In particular, variations of device behavior under changes in operating conditions such as voltage, frequency, and temperature are difficult to represent accurately in an HDL model. Normally, any such parametric behavior is discovered only during hardware testing, when changes to the design are much more difficult and expensive.

### SUMMARY OF THE INVENTION

Methods, apparatus, and computer program products are described for verifying a simulated hardware environment for a simulated device under test (‘DUT’) that include recording, in a software domain, interface signals between the simulated DUT and a simulated hardware device of the simulated hardware environment, the interface signals also including simulated stimulus interface signals and simulated response interface signals; exporting, from the software domain to a playback device of a hardware domain, the recorded interface signals, including the simulated stimulus interface signals and the simulated response interface signals; and playing the exported, recorded simulated stimulus interface signals in the hardware domain from the playback device to the hardware device. In typical embodiments, the hardware device in the hardware domain also including an actual hardware part operating under actual conditions of voltage, frequency, and temperature. Typical embodiments also include, responsive to the playing of the exported, recorded simulated stimulus signals to the hardware device, generating by the hardware device response interface signals from the hardware device to the playback device and comparing, by the playback device, the response interface signals generated by the hardware device and the exported, recorded simulated response interface signals from the simulated hardware device.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a diagram illustrating an exemplary system for verifying a simulated hardware environment for a simulated DUT according to embodiments of the present invention.

FIG. 2 sets forth a block diagram illustrating an exemplary system for verifying a simulated hardware environment for a simulated DUT according to embodiments of the present invention.

FIG. 3 sets forth an exemplary data structure, a table, in which may be recorded data representing interface signals that includes delay data for each interface signal, a representation of a temporal duration for each value of each interface signal.

FIG. 4 sets forth a block diagram of automated computing machinery comprising an exemplary computer useful in verifying a simulated hardware environment for a simulated DUT according to embodiments of the present invention.

FIG. 5 sets forth a flow chart illustrating an exemplary method for verifying a simulated hardware environment for a simulated DUT according to embodiments of the present invention.

FIG. 6 sets forth a flow chart illustrating a further exemplary method for verifying a simulated hardware environment for a simulated DUT according to embodiments of the present invention.

FIG. 7 sets forth a flow chart illustrating an exemplary method for playing exported, recorded simulated stimulus interface signals in a hardware domain from a playback device to a hardware device.

FIG. 8 sets forth a timing diagram illustrating timing relationships among a simulated DUT clock, a playback device clock, a simulated stimulus transition, and a hardware interface clock.

### DETAILED DESCRIPTION OF EXEMPLARY EMBODIMENTS

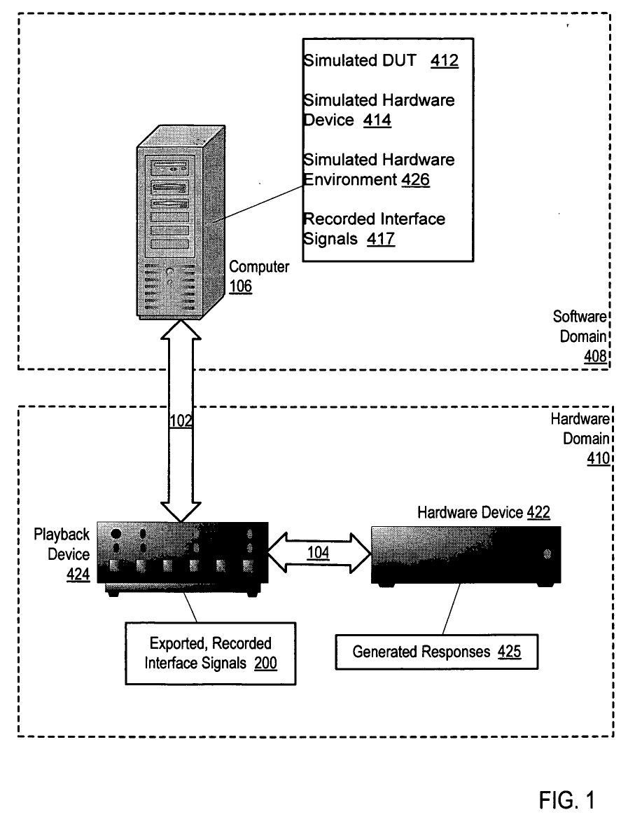

Exemplary methods, apparatus, and products for verifying a simulated hardware environment for a simulated device under test (‘DUT’) according to embodiments of the present invention are described with reference to the accompanying drawings, beginning with FIG. 1. FIG. 1 sets forth a diagram illustrating an exemplary system for verifying a simulated hardware environment for a simulated DUT according to embodiments of the present invention. As explained in more detail below in this specification, the system of FIG. 1 operates generally to verify a simulated hardware environment (426) for a simulated DUT (412) according to embodiments of the present invention by recording interface signals, exporting the recorded interface signals (417) to a playback device (424), playing exported, recorded simulated stimulus interface signals (200) to a hardware device (422), generating response interface signals (425), and comparing the response interface signals and exported, recorded simulated response interface signals.

The system of FIG. 1 includes a computer (106) that is programmed to execute a hardware description language (‘HLD’) that simulates computer hardware in a software domain (408). In this example, computer (106) simulates a device under test (412) and one or more other simulated hardware devices (414) which together make up a simulated hardware environment (426) for the simulated DUT (412). The simulated DUT (412), the simulated hardware device (414), and other simulated hardware devices making up a simulated hardware environment (426) all are implemented as software modules expressed in a hardware description language (‘HDL’) such as Verilog or VHDL, for example. Interface signals between the simulated DUT (412) and simulated hardware device (414) are HDL signals, and recorded interface signals (417) are HDL signal values recorded with signal identifiers and durations, as explained in more detail below. Computer (106) is programmed to export the recorded interface signals (417) to playback device (424), through data communications connection (102) so that playback device (424) has exported, recorded, interface signals (200).

The system of FIG. 1 includes a playback device (424) and a hardware device (422) in a hardware domain (410). The term ‘software domain’ as used in this specification refers to a functional environment where a simulated DUT and a hardware device are simulated in software with functional models implemented as HDL modules. In this specification, such a functional model of a hardware device is represented generally by simulated hardware device (414). Hardware device (422) is the actual hardware device in a hardware domain that is simulated by simulated hardware device (414) in the software domain. The hardware domain (410) is a functional domain where there is no simulated model of the DUT or the hardware device. From the point of view of hardware device (422), playback device (424) appears to emulate a DUT because playback device (424) presents exported recorded stimulus signals through data communications connection (104) having the same content as simulated stimuli presented by simulated DUT (412) to simulated hardware device (414). Playback device (424), unlike computer (106) however, has only exported, recorded signals for playback with no functional model of a DUT.

The domains (408, 410) are not distinguished by the exclusive presence of hardware or software in either domain. The software domain contains software (412, 414, 426) that executes on computer hardware (106), and the hardware domain uses software to operate its hardware components (424, 422). What does distinguish the software domain and the hardware domain is the presence or absence of simulations, software models of hardware devices. That is, the software domain (408) and the hardware domain (410) are distinguished by the presence or absence of software models, simulations of hardware devices (412, 414, 426). The software environment includes a simulation of a DUT (412), a simulation of a hardware device (414), and simulations of other hardware devices representing a simulated hardware environment (426) for the simulated DUT, all of which are simulated in HDL software modules; the simulated DUT and the simulated hardware device (414) communicate with simulated interface signals (417) that are recorded and exported to the hardware domain for playback (200). In fact, although the term ‘software domain’ is adopted generally in this specification, the software domain is sometimes referred to as a ‘simulation environment.’ In contrast, the hardware domain includes no simulations or models, but includes instead a playback device (424) that communicates exported, recorded interface signals (417) through a physical communications connection to the actual hardware device (422) that is modeled back in the software domain by simulated hardware device (414).

A playback device (424) for verifying a simulated hardware environment for a simulated DUT according to embodiments of the present invention may be implemented in a variety of ways. For clarity of explanation, playback device (424) is shown in this example as an embedded system, a separate, special-purpose waveform player for playback of exported, recorded interface signals. A playback device may also be implemented as an FPGA or CPLA, in which case the playback device may be installed on a printed circuit board, an adapter card, included within the same computer (106) that supports the simulation environment; in such a system, the software domain and at least part of the hardware domain would be in the same computer. As a further alternative, a playback device may be implemented as a computer program, a process or thread of execution, on a general purpose computer processor; in which case, again, at least a portion of the hardware domain could be implemented on the same computer (106) that includes the software domain, the simulation environment.

Hardware device (422) is shown in the example of FIG. 1 as an external hardware device such as an external magnetic disk drive, optical disk drive, modem, network router, or the like, separate from the playback device (424) and the computer (106) that houses the simulation environment. An hardware device is exemplified elsewhere in this specification as a device supporting a serial peripheral interface (‘SPI’) such as an electrically erasable programmable read-only memory space (‘EEPROM’). Readers will recognize that a hardware device such as an EEPROM, for example, may be implemented on a printed circuit board or an adapter card and housed within the same computer (106) that hosts the simulation environment; in which case, again, at least a portion of the hardware domain could be implemented on the same computer that includes the software domain.

For a further example: In an exemplary system where a playback device is implemented as an FPGA on an adapter card in a computer that hosts a simulation environment and a hardware device is implemented as a memory such as an EEPROM on an adapter card in the same computer, both the hardware domain and the software domain may be implemented within the same computer. All of which nicely makes the point that the arrangement of computers and other devices making up the exemplary system illustrated in FIG. 1 are for explanation, not for limitation. Data processing systems useful for verifying a simulated hardware environment for a simulated DUT according to embodiments of the present invention may include additional computers, embedded systems, FPGAs, CPLAs, networks, servers, routers, and other devices, not shown in FIG. 1, as will occur to those of skill in the art. Various embodiments of the present invention may be implemented on a variety of hardware platforms and software environments in addition to those illustrated in FIG. 1.

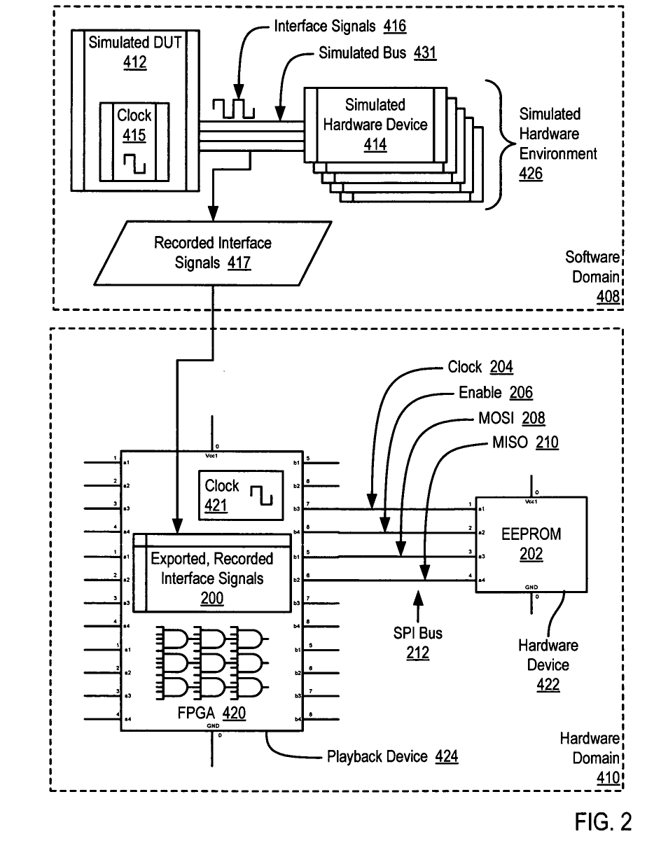

For further explanation, FIG. 2 sets forth a block diagram illustrating an exemplary system for verifying a simulated hardware environment for a simulated DUT according to embodiments of the present invention. The system of FIG. 1 operates generally to verify a simulated hardware environment (426) for a simulated DUT (412) according to embodiments of the present invention by recording interface signals (416) between a simulated DUT (412) and a simulated hardware device (414), exporting the recorded interface signals (417) to a playback device (424), playing exported, recorded simulated stimulus interface signals (200) to a hardware device (422), generating response interface signals, and comparing the response interface signals and exported, recorded simulated response interface signals.

Interface signals (416) include stimuli from the simulated DUT and responses from the simulated hardware device. The exported, recorded interface signals (200) played to the hardware device (422) are the stimuli. In this example, the playback device is represented as an FPGA (420), and the hardware device (422) is represented as an EEPROM (202) that supports a serial peripheral interface, an SPI bus (212) with four data lines: a bus clock (204), an enable line (206), a master-output-slave-input (‘MOSI’) (208), and a master-input-slave-output (‘MISO’) (210). In this example, the simulated hardware device (414) is an HDL module that models the EEPROM, and the simulated bus (431) connecting the simulated DUT (412) and the simulated hardware device (414) simulates the SPI bus (212).

In the system of FIG. 2, the interface signals (416) in the software domain are synchronized with a simulated clock signal (415) of the DUT (412), and the interface signals (204-210) in the hardware domain (410) are synchronized with a hardware clock signal (421) of the FPGA (420). The hardware clock signal (421) is characterized by hardware clock cycles having a period characterized by active transitions, and the simulated clock signal (415) similarly is characterized by simulated clock cycles having a period characterized by active transitions. A benefit of exporting recorded interface signals to the hardware domain for playback is that the hardware clock is much faster than the simulated clock. The simulated clock speed may be simulated as a gigahertz, for example, but speed that is only a simulated speed. Actual speed of a simulated clock is much slower than its simulated speed. Whereas the hardware clock speed may be only 100 megahertz, compared to a simulated speed of a gigahertz, the hardware clock will run much faster. Execution time for a test run will be much shorter in the hardware domain than in the software domain for the same set of interface signals because actual speed of a simulated clock is much slower than its simulated speed and much slower than the hardware clock.

In this example, the hardware device (422), EEPROM (202), is an actual hardware part operating under actual conditions of voltage, frequency, and temperature. In addition, its actual operating voltage, clock frequency, and operating temperature may be varied across test runs to further verify that the simulated hardware device (414) accurately models in the simulated hardware environment of the software domain the behavior of the actual hardware device in the hardware domain.

In the system of FIG. 2, the exported, recorded interface signals (200) include exported, recorded simulated stimulus interface signals from the simulated DUT (412) and exported, recorded simulated response interface signals from the simulated hardware device (414). FPGA (420) is programmed to execute a test run for verifying the operation of the simulated hardware device as part of the simulated hardware environment by playing the exported, recorded simulated stimulus interface signals to EEPROM (202) and comparing response interface signals generated by the EEPROM with the exported, recorded simulated response interface signals from the simulated hardware device (414).

In the example of FIG. 2, the interface signals (416, 204-210) include an interface clock signal (204) characterized by interface clock cycles. The playback device (424) generates the hardware interface clock signal (204) typically by dividing down its hardware clock signal (421) so that the two signals are synchronized with the hardware clock (421) of the playback device running faster than the interface clock signal (204). The hardware clock of the playback device (421) may run at 100 megahertz, for example, while the interface clock signal runs at only 1 megahertz.

Because the two clocks are synchronized and the hardware clock runs faster than the interface clock, the playback device has enough time during each interface clock cycle to compare response interface signals generated by the EEPROM (202) during that interface clock cycle with the corresponding exported, recorded simulated response interface signals from the simulated hardware device (414). And that is how such comparisons are carried out in the example of FIG. 2. That is, in the example of FIG. 2, comparing response interface signals is carried out by comparing, on each interface clock cycle, the response interface signals generated by the hardware device and the corresponding exported, recorded simulated response interface signals from the simulated hardware device. The response interface signals generated by the hardware device are responses to particular stimulus signals. The corresponding exported, recorded simulated response interface signals from the simulated hardware device are the signals generated by the simulated hardware device in the software domain in response to the same stimulus signals from the simulated DUT.

In the example of FIG. 2 and in many similar systems having data communications (212) between a playback device (424) and a hardware device (422), read and write activity, communications of stimulus signals and response signals, across the interface may be separated by large time gaps, especially when sampled at the high speed of the simulated clock (415). Some compression of the recorded interface signals is typically included in order to avoid extremely large recorded datasets. Such compression may be achieved, for example, by recording a duration or delay value along with the signal identification and signal value for each signal and each change in a value of a signal.

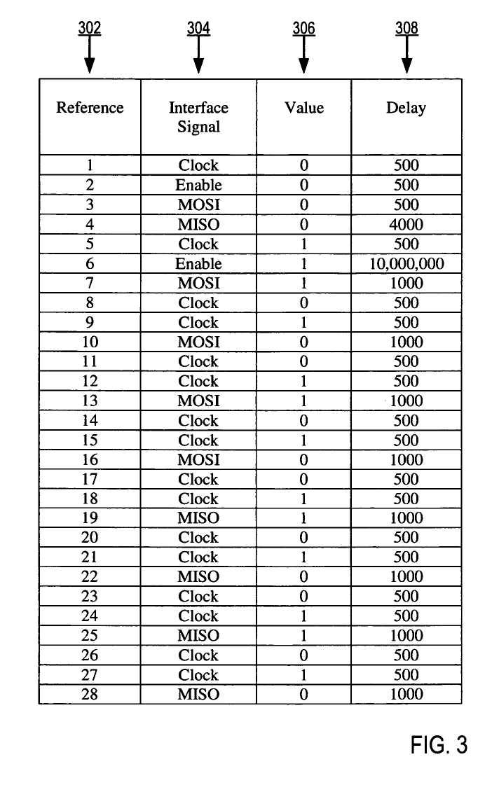

For further explanation, FIG. 3 sets forth an exemplary data structure, a table, in which may be recorded data representing interface signals that includes delay data for each interface signal, a representation of a temporal duration for each value of each interface signal. Each row or record in the exemplary table of FIG. 3 represents a value of a signal on an interface. The table of FIG. 3 has four columns. Column (302) contains reference values, a sequential index for the rows of the structure, including here only for convenience of reference. Column (304) contains interface signal identifiers. The interface signals represented in this examples are interfaced signals of an SPI similar to the interface signals depicted at references (204-210) on FIG. 2, an SPI clock, enable, MOSI, and MISO. Column (306) contains signal values. And column (308) sets for a temporal duration, labeled ‘delay,’ for each value of each interface signal. The temporal durations of the signal values are expressed in simulated clock cycles. So if the simulated clock of the DUT in the software domain has a clock speed of 1.0 gigahertz, for example, then the delays in column (308) are expressed in nanoseconds.

In the example of FIG. 3, for convenience of explanation, a simulated clock speed of 1.0 gigahertz is assumed. Readers will therefore expect to see interface clock state changes every 500 nanoseconds, and such changes are shown in records 1, 5, 8, 9, 11, 12, 14, 15, and so on. The interface clock signal in this example is active on its positive edge and drives bus latches so that data values change on the interface synchronously with the clock on its positive transitions. On the clock's first positive transition, at record 5, the enable line goes active for 10,000,000 nanoseconds. In the first four interface clock cycles, MOSI drive four stimulus bits onto the bus, 1, 0, 1, 0, at records 7, 10, 13, and 16 respectively. On the next four interface clock cycles, MISO drive four response bits onto the bus, 1, 0, 1, 0, at records, 19, 22, 25, and 28 respectively.

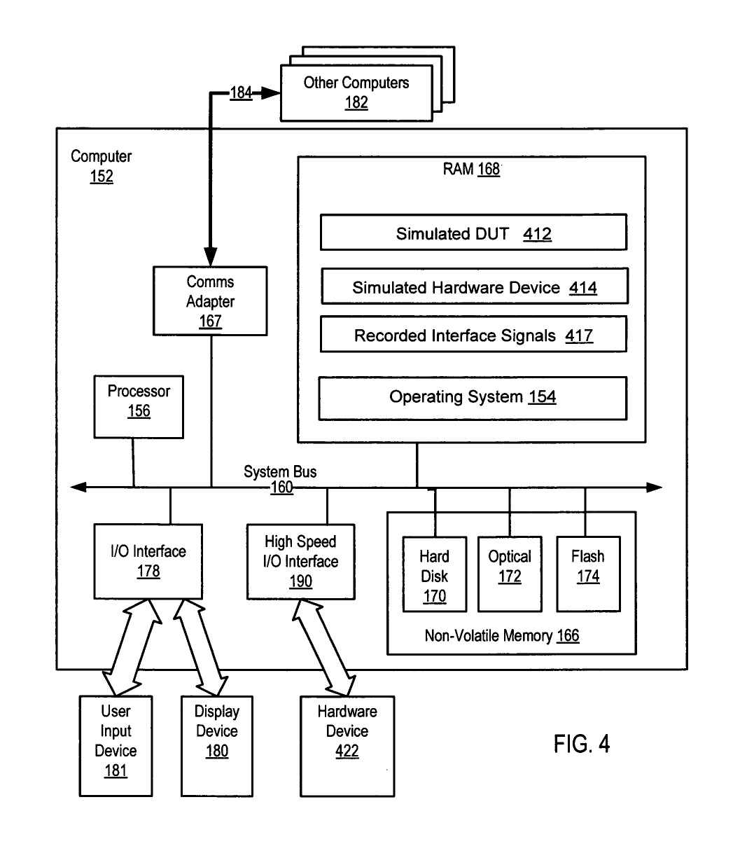

Verifying a simulated hardware environment for a simulated DUT in accordance with embodiments of the present invention is generally implemented with computers, that is, with automated computing machinery. In the system of FIG. 1, for example, the computer (106) hosting the simulation environment, the playback device (424), and the hardware device (422) are all implemented to some extent at least as computers. For further explanation, therefore, FIG. 4 sets forth a block diagram of automated computing machinery comprising an exemplary computer (152) useful in verifying a simulated hardware environment for a simulated DUT according to embodiments of the present invention. The computer (152) of FIG. 4 includes at least one computer processor (156) or ‘CPU’ as well as random access memory (168) (“RAM”) which is connected through a system bus (160) to processor (156) and to other components of the computer.

Stored in RAM (168) is a simulated DUT (412), a computer program module comprising computer program instructions in an HDL. Also stored RAM (168) is a simulated hardware device (414), part of a simulated hardware environment for the simulated DUT, also a computer program module comprising computer program instructions in an HDL. Also stored in RAM is a set of recorded interface signals (417) representing communications between the simulated DUT and the simulated hardware device.

Also stored in RAM (168) is an operating system (154). Operating systems useful in computers according to embodiments of the present invention include UNIX™, Linux™, Microsoft NT™, AIX™, IBM's i5/OS™, and others as will occur to those of skill in the art. Operating system (154), simulated DUT (412), simulated hardware device (414), and recorded interface signals (417) in the example of FIG. 4 are shown in RAM (168), but many components of such software may be stored in non-volatile memory (166) also.

Computer (152) of FIG. 4 includes non-volatile computer memory (166) coupled through a system bus (160) to processor (156) and to other components of the computer (152). Non-volatile computer memory (166) may be implemented as a hard disk drive (170), optical disk drive (172), electrically erasable programmable read-only memory space (‘EEPROM’ or ‘Flash’ memory) (174), RAM drives (not shown), or as any other kind of computer memory as will occur to those of skill in the art.

The example computer of FIG. 4 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice. Computer (152) also includes a high-speed input/output adapter (190) for use in embodiments where an actual hardware device a playback device is implemented as a computer program on a general purpose computer processor and the actual hardware device (422) with which it communicates is located external to the computer on which the playback device is implemented.

The exemplary computer (152) of FIG. 4 includes a communications adapter (167) for implementing data communications (184) with other computers (182). Such data communications may be carried out through serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for determining availability of a destination according to embodiments of the present invention include modems for wired dial-up communications, Ethernet (IEEE 802.3) adapters for wired network communications, and 802.11b adapters for wireless network communications.

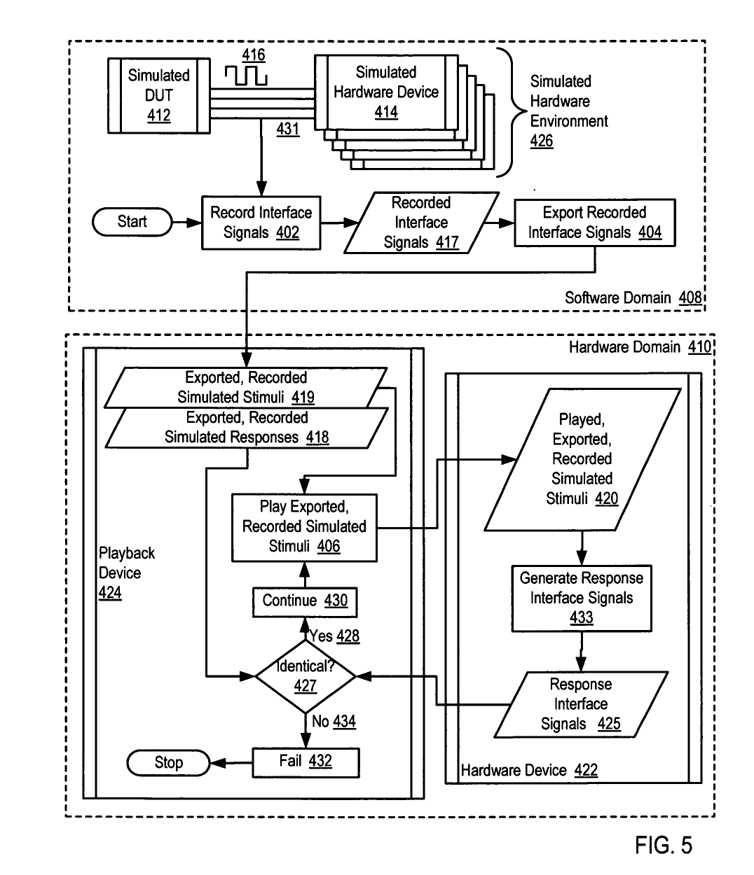

For further explanation, FIG. 5 sets forth a flow chart illustrating an exemplary method for verifying a simulated hardware environment (426) for a simulated DUT (412) according to embodiments of the present invention that includes recording (402), in a software domain (408), interface signals (416) between the simulated DUT (412) and a simulated hardware device (414) of the simulated hardware environment (426), the interface signals (416) further comprising simulated stimulus interface signals and simulated response interface signals. The record function (402) may be implemented as an HDL module in a software simulation environment in a fashion similar to the simulated hardware device (414) and the simulated DUT (412). As described above with regard to FIG. 3, recording interface signals may be carried out by recording delay data for each interface signal that includes a representation of a temporal duration for each value of each interface signal.

The method of FIG. 5 also includes exporting (404), from the software domain (408) to a playback device (424) of a hardware domain (410), the recorded interface signals (417), including the simulated stimulus interface signals and the simulated response interface signals. In the method of FIG. 5, the simulated stimulus interface signals and the simulated response interface signals are represented as exported, recorded, simulated interface signals (419) and exported, recorded, simulated response interface signals (418).

A simulation environment in the software domain may export the recorded interface signals as, for example, a waveform file. Examples of waveform files useful for exporting recorded interface signals include RIFF files, IFF files, and RIFX files. RIFF (Resource Interchange File Format) is the tagged file structure developed for multimedia resource files. The structure of a RIFF file is similar to the structure of an Electronic Arts IFF (Interchange File Format) file. RIFF has a counterpart, RIFX, that is used to define RIFF file formats that use the Motorola integer byte-ordering format rather than the Intel format. A RIFX file is the same as a RIFF file, except that the first four bytes are ‘RIFX’ instead of ‘RIFF’, and integer byte ordering is represented in Motorola format.

The method of FIG. 5 also includes playing (406) the exported, recorded simulated stimulus interface signals (419) in the hardware domain from the playback device (424) to the hardware device (422). The playback device (424) is programmed to extract the simulated stimulus signals (419) from the exported interface signals and present them through a data communications medium such as a PCI bus, for example, to the hardware device (422). Playing such stimulus interface signals includes synchronizing them with an actual bus clock just as the simulated stimulus signals were synchronized with a simulated interface clock in the software domain.

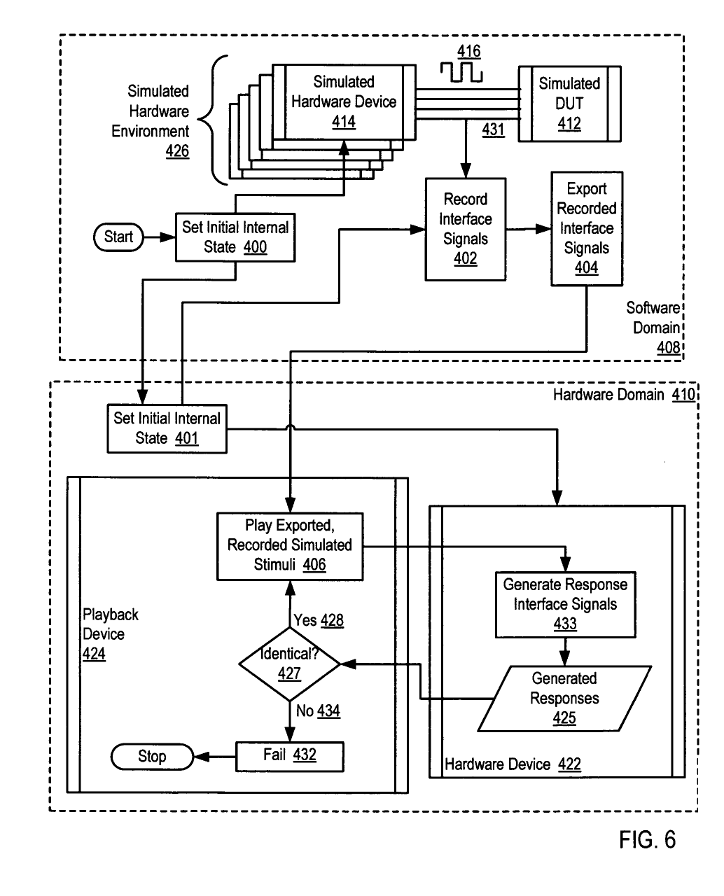

The method of FIG. 5 also includes, responsive to the playing of the exported, recorded simulated stimulus signals to the hardware device, generating (433) by the hardware device response interface signals (425) from the hardware device (422) to the playback device (424). In the method of FIG. 5, the hardware device (422) in the hardware domain (410) typically is an actual hardware part operating under actual conditions of voltage, frequency, and temperature. The method of FIG. 5 also includes comparing (427), by the playback device, the response interface signals (425) generated (433) by the hardware device and the exported, recorded simulated response interface signals (418) from the simulated hardware device (414). As described above, the interface signals typically include an interface clock signal characterized by interface clock cycles, and comparing the response interface signals may be carried out by comparing the response interface signals generated by the hardware device and the exported, recorded simulated response interface signals from the simulated hardware device on each cycle of the interface clock. In the method of FIG. 6, if the response interface signals (425) generated (433) by the hardware device and the exported, recorded simulated response interface signals (418) from the simulated hardware device (414) are identical, processing continues (428). If the response interface signals (425) generated (433) by the hardware device and the exported, recorded simulated response interface signals (418) from the simulated hardware device (414) are not identical (434), the playback device (424) is programmed to signal a verification failure (432).

For further explanation, FIG. 6 sets forth a flow chart illustrating a further exemplary method for verifying a simulated hardware environment (426) for a simulated DUT (412) according to embodiments of the present invention that is similar to the method of FIG. 5. That is, the method of FIG. 6 includes recording (402) interface signals (416), exporting (404) the recorded interface signals (417) to a playback device (424), playing (406) the exported, recorded simulated stimulus interface signals (419) to a hardware device (422), generating (433) response interface signals (425), and comparing (427) the response interface signals (425) and the exported, recorded simulated response interface signals (418), all of which operate as described above with reference to the method of FIG. 5.

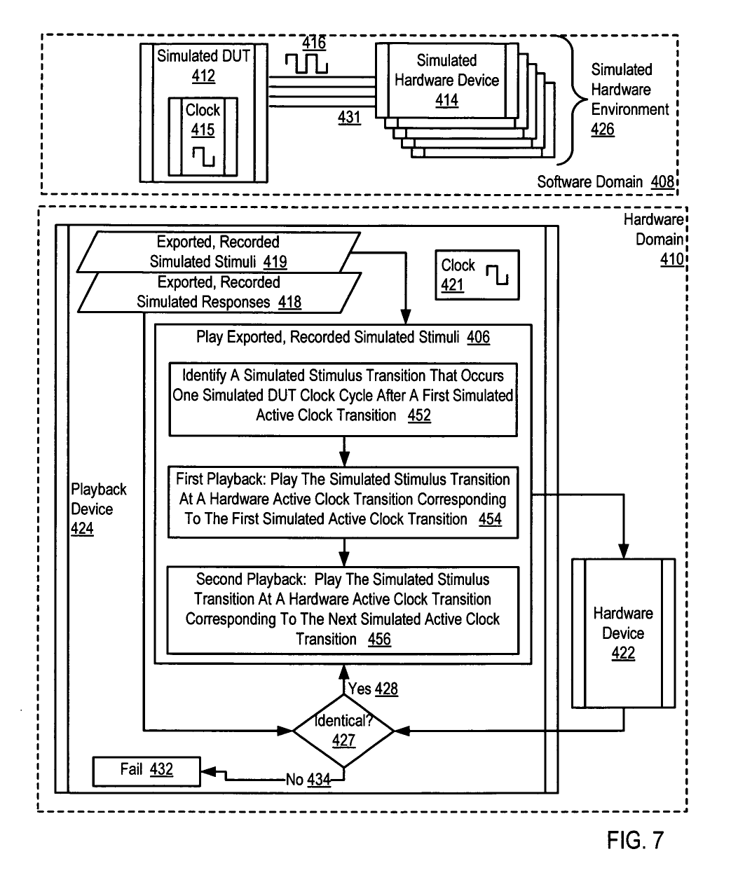

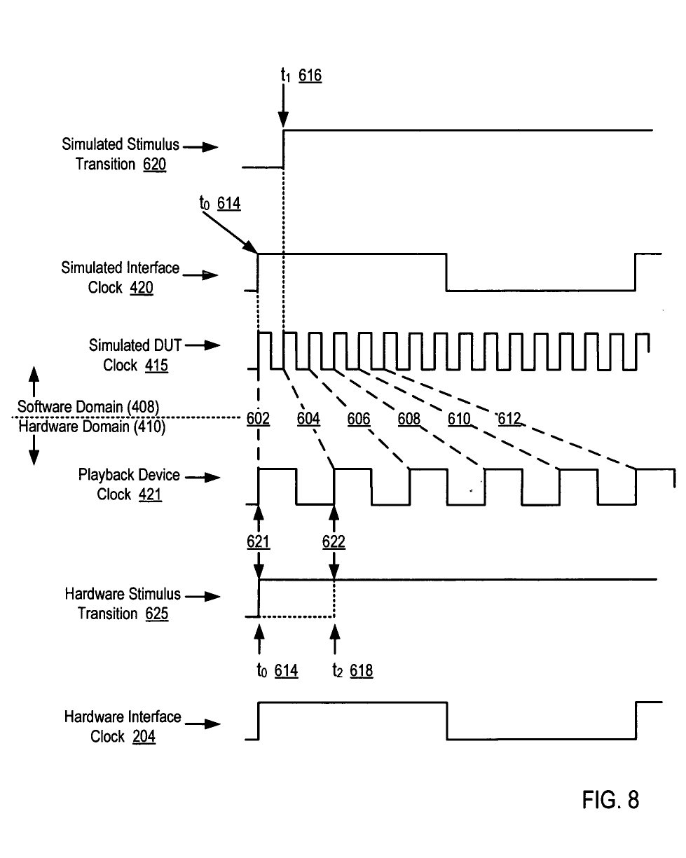

In addition, however, the method of FIG. 6 also includes setting (400) the simulated hardware device (414) to an initial internal state and setting (401) the hardware device (422) to the same initial internal state. Consider the example of the EEPROM as a hardware device in the hardware environment of a DUT. The EEPROM is a memory. Stimulus interface signals for the EEPROM include memory addresses, and response interface signals from the EEPROM include the data contents of the addresses. If a response is to be the same for a stimulus address in both the hardware domain and the software domain, the contents of the memory at that address must be the same in both the software domain and the hardware domain. For further explanation, FIG. 7 sets forth a flow chart illustrating an exemplary method for playing (406) exported, recorded simulated stimulus interface signals (419) in a hardware domain (410) from a playback device (424) to a hardware device (422). In the following discussion, the method of FIG. 7 is explained both with reference to FIG. 7 and also with reference to FIG. 8. In the method of FIG. 7, the software domain includes a simulated DUT clock signal (415) having a simulated DUT clock speed, the simulated DUT clock signal characterized by simulated active clock transitions. Also in the method of FIG. 7, the playback device has a hardware clock (421) having a hardware clock speed slower than the simulated clock speed, the hardware clock characterized by hardware active clock transitions.

In the method of FIG. 7, playing (406) exported, recorded simulated stimulus interface signals (419) includes identifying (452) a simulated stimulus transition that occurs one simulated DUT clock cycle after a first simulated active clock transition. Identifying (452) a simulated stimulus transition that occurs one simulated DUT clock cycle after a first simulated active clock transition is further explained with reference to FIG. 8. FIG. 8 sets forth a timing diagram illustrating timing relationships among a simulated stimulus transition (620), a simulated interface clock (420), a simulated DUT clock (415), a playback device clock (421), a hardware stimulus transition (625), and a hardware interface clock (204). The hardware stimulus transition (625) is the analog in the hardware domain of the simulated stimulus transition (620). The time scales of the clock signals in FIG. 8 are not exact but are relatively correct. That is, the simulated DUT clock (415) is faster than the playback device clock (421), and the playback device clock (421) is faster than the hardware interface clock (204). Also in the example of FIG. 8, the simulated DUT clock (415) and the playback device clock (421) are generally synchronized according to corresponding active clock transitions so that interface signals that are presented to a simulated bus on an active transition of the simulated DUT clock (415) also are presented to a hardware interface on a corresponding active transition of the playback device clock (421). Several corresponding active transitions of the simulated DUT clock and the playback device clock are represented by dotted lines (602, 604, 606, 608, 610, 612).

The simulated stimulus transition at time t₁ (616) occurs one simulated DUT clock cycle after a first simulated active clock transition at t₀ (614). Such a simulated stimulus may be any interface signal having the timing relationship of occuring one simulated DUT clock cycle after a first simulated clock transition, including, for example, enable signals and data lines such as MISO or MOSI signals. Such a simulated stimulus transition can not be exactly replayed by the playback device in real time because the actual playback device clock is slower than the simulated DUT clock. Consider, for example, a simulated DUT clock having a speed of 1.0 gighertz and a playback device clock having a speed of 100 megahertz. In such an example, a simulated stimulus transition one simulated DUT clock cycle after a first simulated active clock transition occurs one nanosecond after the first simulated active clock transition. In the hardware domain, however, nine more nanoseconds must elapse before the next active clock transition of the playback device clock. The interval of exactly one nanosecond can not be exactly duplicated in the hardware domain of this example.

The playback device can not duplicate the exact timing of the simulated stimulus transition, but it can verify the operation of a hardware device by playing the stimulus transition in the hardware domain twice. The playback device is programmed so that such a hardware analog of the simulated stimulus transition is played twice, once (621) at the playback device clock transition corresponding to the simulated DUT clock transition at to and again (622) at time t₂ (618) on the playback device clock transition corresponding to the next simulated DUT clock transition at t₁ (616). Again with reference to FIG. 7, therefore: In the method of FIG. 7, playing (406) exported, recorded simulated stimulus interface signals (419) also includes playing (454), in a first playback of the exported, recorded simulated stimulus interface signals (419), the simulated stimulus transition at a hardware active clock transition corresponding to the first simulated active clock transition. In the method of FIG. 7, playing (406) exported, recorded simulated stimulus interface signals (419) also includes playing(456), in a second playback of the exported, recorded simulated stimulus interface signals (419), the simulated stimulus transition at a hardware active clock transition corresponding to the next simulated active clock transition. Both playback scenarios are approximations in the hardware domain of the DUT simulation, but if both playback cases yield passing results, the playback can be considered a conservative verification of the simulated hardware environment.

For further explanation, a pseudocode example of a waveform player that may be adapted to operate either as a playback device or a simulated hardware device verifying a simulated hardware environment for a simulated DUT according to embodiments of the present invention is set forth below. ‘Pseudocode’ is an example of verifying a simulated hardware environment for a simulated DUT according to embodiments of the present invention presented for convenience of explanation in the form of computer program code, not an actual working model and not a form of code in any particular programming language.

In another exemplary embodiment, an HDL module adapted from the psuedocode example below may be used to implement a simulated hardware device. In order to provide a clear description, the example below describes the function of the pseudocode as a playback device. As will be apparent to those of skill in the art, there will be differences between actual program code written to implement a simulated hardware device and actual program code written to implement a playback device. For example, to implement a playback device, the pseudocode is adapted to present a stimulus waveform to a hardware device; whereas, to implement a simulated hardware device, the pseudocode is adapted to present a response waveform to a device under test. Accounting for such differences when implementing actual program code is well within the skill of those of ordinary skill in the art.

The following pseudocode example is expressed in a syntax of an example HDL similar to Verilog or VHDL—useful, for example, in an exemplary embodiment in which a playback device is implemented as an FPGA. The use of HDL in this example is for explanation only, not a limitation of the present invention. When a playback device is implemented on a personal computer or workstation with a high-speed I/O port instead of an FPGA, the C programming language may be preferred to an HDL, for example. When a playback device is implemented as an embedded controller, for a further example, then an assembly language may be preferred to an HDL.

A pseudocode example of a software module implementing a waveform player:

```
module wave_player( RST_, CLK, SPI_CLK, SPI_SO, SPI_EN_n, SPI_SI);
  input RST_, CLK, SPI_SI;
  inout SPI_CLK, SPI_EN_n, SPI_SO;
  wire sigm, init, spi_en_ram, spi_so_ram, spi_clk_ram,
    spi_en_oe, spi_clk_oe, spi_so_oe,
    [0:8] pc, [7:0] delay, [7:0] data;
  wire rst;  // active ‘1’ reset
  wire zcnt;  // zero count of delay
  wire dec;  // decrement delay counter
  wire inc;  // increment program counter
  wire endd;  // end of program, program counter == 9′h1FF
  assign sigm  = (inc || init);
  RAMB4_S8 data_mem (.WE(1′b0), .EN(sigm), .RST(1′b0), .CLK(CLK),
        .ADDR(pc[0:8]), .DI(8′h00), .DO(data[7:0]));
  RAMB4_S8 delay_mem (.WE(1′b0), .EN(1′b1), .RST(1′b0), .CLK(CLK),
          .ADDR(pc[0:8]), .DI(8′h00), .DO(delay[7:0]));
  player_state player_state( .clk(CLK),  .rst(rst) ,
        .zcnt(zcnt),  .last(endd),
        .inc(inc),  .dec(dec),
        .load(load),  .init(init),
        .spi_si(SPI_SI),  .spi_en(SPI_EN_n),
        .spi_clk(SPI_CLK), .data_0(data[0]));
  pc_mod pc_mod( .clk(CLK), .rst(rst), .inc(inc),
            .pc( pc ), .endd( endd ));
  count count( .clk(CLK), .rst(rst), .dec( dec ),
      .in( delay[7:0] ), .load(load), .zcnt( zcnt ) );
  assign rst = ! RST_;
  assign spi_en_oe  = ˜data[5];
  assign spi_en_ram  = data[4];
  assign spi_clk_oe  = ˜data[7];
  assign spi_clk_ram  = data[6];
  assign spi_so_oe  = ˜data[3];
  assign spi_so_ram  = data[2];
  assign SPI_EN_n = (spi_en_oe ? spi_en_ram : 1′bz );
  assign SPI_CLK = ( spi_clk_oe ? spi_clk_ram : 1′bz );
  assign SPI_SO = ( spi_so_oe ? spi_so_ram : 1′bz );
endmodule
```

This example implements a waveform player named wave_player having nodes for a reset input (‘RST_’), a clock input (‘CLK’), and an SPI serial input (‘SPI_SI’). SPI_SI is an input node that corresponds to an MISO, master input slave output in SPI standard terminology. Wave_player also has bidirectional nodes (‘inouts’) for an SPI clock (‘SPI_CLK’), an SPI enable (‘SPI_EN_n’), and an SPI serial output (‘SPI_SO’). SPI_SO corresponds to an MOSI, master output slave input in SPI standard terminology.

Wave_player instantiates the following signals or ‘wires’:

```
sigm - assigned to inc or init
init - a signal indicating ‘init and reset’ state of the state machine
    ‘player_state’
spi_en_ram - the SPI enable signal from a recorded stimulus
    waveform, assigned to data array bit data [4]
spi_so_ram - the SPI serial output signal from a recorded stimulus
    waveform, assigned to data array bit (data [2])
spi_clk_ram - the SPI clock signal from a recorded stimulus
    waveform, assigned to data array bit data [6] to generate driver
    enables
spi_en_oe - a tri-state output enable for the SPI enable signal, assigned
    to the inverse of bit 5 of the data array (˜data [5])
spi_clk_oe - a tri-state output enable assigned to the inverse of bit 7
    of the data array (˜data [7])
spi_so_oe - a tri-state output enable assigned to the inverse of bit 3
    of the data array (˜data [3])
[0:8] pc - program counter signals
[7:0] delay - state duration delay signal
[7:0] data - output data signals from the memory named ‘data_mem,’
    providing the recorded stimulus waveform to wave_player
    signal
rst - active ‘1’ reset signal
zcnt - zero count of delay counter
dec - signal to decrement delay counter
inc - increment signal for program counter
endd - signal indicating end of program
```

In Verilog, anything on the left hand side of a procedural assignment (an assignment in an ‘always’ block) must be declared as a register data type. Everything else in Verilog, including any signal used in a Verilog ‘continuous assignment,’ is a net data type, including, for example, a ‘wire.’. A VHDL ‘process’ is roughly equivalent to a Verilog ‘always’ block and a VHDL ‘concurrent signal assignment’ is roughly equivalent to a Verilog ‘continuous assignment,’ but VHDL does not require different data type declarations for process and concurrent signal assignments. In VHDL, ‘signals’ are commonly used in place of both Verilog register and net data types. In this specification, subject to context, the terms ‘signal,’ ‘wire,’ and ‘register’ are used as synonyms.

Wave_player instantiates two FPGA memories each of 512 8-bit bytes, one named ‘data_mem’ and another named ‘delay_mem.’ Data_mem provides signals in an 8-bit array named ‘data ’ for each recorded stimulus signal of a recorded stimulus waveform to be played to a hardware device across an SPI bus. The recorded stimulus signals are named SPI_CLK, SPI_EN, and SPI_SO, corresponding as mentioned above to the SPI bus lines for an SPI clock, an SPI enable line, and an SPI MOSI line.

The waveform data is encoded into a 2 bit field for each output signal:

assign spi_en_oe = ˜data[5];
assign spi_en_ram = data[4];
assign spi_clk_oe = ˜data[7];
assign spi_clk_ram = data[6];
assign spi_so_oe = ˜data[3];
assign spi_so_ram = data[2];

The 2 bit encoding allows for 4 output states being logic “0”, logic “1,” tri-state, and a reserved state. This makes 3×2=6 bits. The other two bits store expected value of the input, SPI_SI, allowing for “on the fly” checking of the response of the SPI hardware device versus the simulation expected result, that is, a response value from a recorded response waveform. The second memory, ‘delay_mem,’ contains a delay count which specifies the delay in clock counts for which the values in the corresponding data memory, ‘data mem,’ are output through the ‘data’ wires.

Wave player also instantiates a state machine named ‘player_state’ which is responsible for sequencing through the stimulus data and delay memory from a first memory location through the last memory location in a simulation run. Player_state also interacts with a program counter named ‘pc’ and the delay counter, here named ‘count.’ The function of the program counter is to store the current address being presented to the data_mem and delay_mem memories. The function of the delay counter is to count out the delay specified for each stimulus in the recorded stimulus waveform.

A pseudocode example of player_state is:

module player_state( init, load, inc, dec, clk, rst, last,

zcnt, spi_si, spi_en, spi_clk, data_0);

| output | init, load, me, dec; |
|---|---|
| input | clk, rst, last, zcnt, spi_si, spi_en, spi_clk, data_0; |
| wire | load, rst; |
| reg [5:1] state, next_state; | |
| reg | fail,spi_clk_d, spi_clk_dd, spi_si_d, spi_si_dd; |

parameter MWS_INIT = 1; // init and reset state
parameter MWS_LOAD = 2; // load fpga RAM signals
parameter MWS_CNT = 3; // decrement delay counter
parameter MWS_NC = 4; // incrememnt program counter
parameter MWS_END = 5; // end state
parameter MWS_WAIT = 6; // delay count
wire mws_load = state[MWS_LOAD], mws_inc =
state[MWS_INC],

mws_ent = state[MWS_CNT], mws_init = state[MWS_INIT],
spi_clk_rising;

assign init = mws_init, load = mws_load, inc = mws_inc,
dec = mws_cnt;
always @ (posedge clk or posedge rst)

if(rst) state <= 5'b00001;
else state <= next_state

always @ ( rst or state or last or zcnt )
begin

| | |
|---|---|
| next_state = 5'b00000; | // clear next_state |

casex ( 1'b1 )

state[MWS_INIT]: next_state[MWS_LOAD = 1;
state[MWS_LOAD]: next_state[MWS_CNT] = 1;
state[MWS_INIT]: if(zcnt) next_state[MWS_INC] = 1;

else next_state[MWS_CNT] = 1;

state[MWS_INC]: if(last) next_state[MWS_END] = 1;

else next_state[MWS_WAIT] = 1;

state[MWS_WAIT]: next_state[MWS_LOAD] = 1;
state[MWS_END]: next_state[MWS_END] = 1;
default: next_state[MWS_INIT] = 1;

endcase

end
always @ (posedge clk or posedge rst)

if(rst) begin spi_clk_d <= 0 spi_si_d <= 1; spi_si_dd <= 1;
end
else begin spi_clk_d <= spi_clk; spi_si_d <= spi_si;

spi_si_dd <= spi_si_d;

end

assign spi_clk_rising = (spi_clk && !spi_clk_d);
always @ (posedge clk or posedge rst)

if( rst ) fail <= 1'b0;
else if ((fail == 0) && (spi_clk_rising == 1)

&& (spi_en == 0))

if ((spi_si !== data_0) && (spi_si_d !== data_0)

&& (spi_si_dd !== data_0))
fail <= 1'b1;

endmodule

player_state player_state( .clk(CLK ), .rst(rst) ,

.zcnt(zcnt), .last(endd),
.inc(inc), .dec(dec),
.load(load), .init(init),
.spi_si(SPI_SI), .spi_en(SPI_EN_n),
.spi_clk(SPI_CLK), .data_0(data[0]));

maps player_state's nodes to signals in wave_player as follows:

```
clk maps to CLK, a system clock for a playback device or a simulated hardware
        device
rst maps to rst, an active ‘1’ reset signal
zcnt maps to zcnt, the zero count of the delay counter
last maps to endd, a signal indicating end of program
inc maps to inc, the increment signal for program counter
dec maps to dec, the signal to decrement the delay counter
load maps to load, a load signal for the delay counter
init maps to init, a signal for the ‘init and reset’ state of player_state
spi_si maps to SPI_SI, a node for response data from a hardware device
spi_en maps to SPI_EN_n, a node for an SPI enable signal from a recorded
        stimulus waveform
spi_clk maps to SPI_CLK, a node for an SPI clock signal from a recorded
        stimulus waveform
data_0 maps to data[0], a node for an expected response signal from a hardware
        device (recorded in a previous iteration)
```

Player_state declares parameters representing the following machine states:

parameter MWS_INIT = 1; // init and reset state
parameter MWS_LOAD = 2; // load fpga RAM signals
parameter MWS_CNT = 3; // decrement delay counter
parameter MWS_INC = 4; // increment program counter
parameter MWS_END = 5; // end state
parameter MWS_WAIT = 6; // delay count

Player_state instantiates the following signals or ‘wires’:

mws_load, a signal for the MWS_LOAD machine state
mws_inc, a signal for the MWS_INC machine state
mws_cnt, a signal for the MWS_CNT machine state
mws_init, a signal for the MWS_INIT machine state
spi_clk_rising, a signal representing a rising edge of an SPI
clock signal

Player_state, through ‘continuous assignments,’ assigns to init the value of the mws_init machine state, to load the value of the mws_load machine state, to inc the value of the mws_inc machine state, and to dec the value of the mws_cnt machine state.

Through the always block:

```
always @ (posedge clk or posedge rst)
    if(rst) state <= 5′b00001;
    else state <= next_state;
```

player_state clears the state signal on reset and moves to the next state of the state machine on a positive clock edge.

Player_state implements a sequence of machine states with the following always block, which executes when rst, state, last, or zcnt is true:

```
always @ ( rst or state or last or zcnt )
begin
  next_state = 5′b00000;  // clear next_state
  casex ( 1′b1 )
    state[MWS_INIT]: next_state[MWS_LOAD] = 1;
    state[MWS_LOAD]: next_state[MWS_CNT] = 1;
    state[MWS_CNT]: if(zcnt) next_state[MWS_INC] = 1;
        else next_state[MWS_CNT] = 1;
    state[MWS_INC]: if(last) next_state[MWS_END] = 1;
          else next_state[MWS_WAIT] = 1;
    state[MWS_WAIT]: next_state[MWS_LOAD] = 1;
    state[MWS_END]: next_state[MWS_END] = 1;
    default:  next_state[MWS_INIT] = 1;
  endcase
end
```

This always block clears next_state and then:

```
if state is MWS_INIT, sets next_state to MWS_LOAD;
if state is MWS_LOAD] , sets next_state to MWS_CNT;
if state is MWS_CNT] , sets next_state to MWS_INC if zcnt is true, otherwise
  sets next_state to MWS_CNT;
if state is MWS_INC, sets next_state to MWS_END if last is true, that is, if all the
  response data has been played back to the hardware device, otherwise sets
  next_state to MWS_WAIT;
if state is MWS_WAIT, sets next_state to MWS_LOAD; and
if state is MWS_END, sets next_state to MWS_END.
```

Through the always block:

```
always @ (posedge clk or posedge rst)
  if(rst) begin spi_clk_d <= 0; spi_si_d <= 1; spi_si_dd <= 1;
  end
  else begin spi_clk_d <= spi_clk; spi_si_d <= spi_si;
    spi_si_dd <= spi_si_d;
  end,
```

player_state saves the current response the three most recent response data values from the hardware device in spi_si, spi_si_d, and spi_si_dd, which are sampled on the three most recent system clock positive edges, that is, the rising edge of the ‘clk’ signal. Then, in the always block:

```
always @ (posedge clk or posedge rst)
    if ( rst ) fail <= 1′b0;
    else if ((fail == 0) && (spi_clk_rising == 1)
            && (spi_en == 0))
        if ((spi_si !== data_0) && (spi_si_d !== data_0)
            && (spi_si_dd !== data_0))
            fail <= 1′b1;
```

player_state, by this test:

```
if ((spi_si !== data_0) && (spi_si_d !== data_0)
    && (spi_si_dd !== data_0))
    fail <= 1′b1;
```

detects a response error only if all three most recent response data values are equal to one another and not equal to the expected response value in data_0.

A pseudocode example of the delay counter is the following HDL module named ‘count’:

| module count( clk, rst, dec, in, load, zcount); | |
|---|---|
| output zcount, dec; | |
| input | in, clk, rst, load; |
| reg [8:1] | delay counter; |

```
    assign zcnt = (delay[0:7] = 8′h01);
    always @ (posedge clk or posedge rst)
        if(rst)  delay counter <= 8′b000000000;
        else if (load) delay counter <= in;
        else if (dec) delay counter−−;
endmodule
```

The nodes of the count module include an ‘in’ node mapped to the data output wires of the delay memory ‘delay mem’ by the instantiation of the delay counter in wave_player:

count count( .clk(CLK), .rst(rst), .dec( dec ),
.in( delay[7:0] ), .load(load), .zcnt( zcnt ) );

The count module instantiates an 8-bit register named ‘delay counter’ to hold the delay period for a recorded stimulus from the recorded stimulus waveform. Then, through the always block:

```
always @ (posedge clk or posedge rst)
    if(rst)  delay counter <= 8′b000000000;
    else if (load) delay counter <= in;
    else if (dec) delay counter−−;
```

the count module clears the delay counter upon rst, loads the delay counter with the delay period for a recorded stimulus on the positive edge of the system clock if ‘load’ is true, and decrements the delay counter if ‘dec’ is true. With the continuous assignment:
assign zcnt=(delay[0:7]=8′h01);
   the count module sets zcnt true when the delay counter value decrements to 1.

A pseudocode example of the program counter is the following HDL module named ‘pc_mod’:

```
module pc_mod(clk, rst, inc, pc, endd);
    input inc, clk, rst;
    output inc, endd;
    reg [9:1] pc;
    assign endd = (pc[9:1] == 9′h1ff)
    always @ (posedge clk or posedge rst)
        if (rst) PC <= 9′b000000000;
        else if (inc) pc++;
endmodule
```

The nodes of pc_mod include a ‘pc’ node mapped to the address signals of the memories ‘data_mem’ and ‘delay_mem’ by the instantiation of the program counter, pc_mod, in wave_player:

pc_mod pc_mod( .clk(CLK), .rst(rst), .inc(inc),
.pc( pc ), .endd( endd )).

Pc_mod instantiates an 9-bit register named ‘pc’ to hold the current address of the recorded stimulus and delay data presented to the data memory ‘data_mem’ and the delay memory ‘delay_mem.’ The memories are 512 bytes each. Pc_mod sets signal ‘endd’ true when the value of pc reaches hexadecimal 1 ff=decimal 255. Through the always block:

```
always @ (posedge clk or posedge rst)
    if (rst) pc <= 9′b000000000;
    else if(inc) pc++;
```

pc_mod clears pc upon reset, rst=true, and if ‘inc’ is true on a positive clock edge, pc_mod increments the value of pc.

Exemplary embodiments of the present invention are described largely in the context of a fully functional computer system for verifying a simulated hardware environment for a simulated DUT. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for verifying a simulated hardware environment for a simulated device under test (‘DUT’), the method comprising:
recording, in a software domain, interface signals between the simulated DUT and a simulated hardware device of the simulated hardware environment, the interface signals further comprising simulated stimulus interface signals and simulated response interface signals;
exporting, from the software domain to a playback device of a hardware domain, the recorded interface signals, including the simulated stimulus interface signals and the simulated response interface signals; and
playing the exported, recorded simulated stimulus interface signals in the hardware domain from the playback device to the hardware device.

2. The method of claim 1 wherein the hardware device in the hardware domain further comprises an actual hardware part operating under actual conditions of voltage, frequency, and temperature.

3. The method of claim 1 further comprising:
responsive to the playing of the exported, recorded simulated stimulus signals to the hardware device, generating by the hardware device response interface signals from the hardware device to the playback device; and
comparing, by the playback device, the response interface signals generated by the hardware device and the exported, recorded simulated response interface signals from the simulated hardware device.

4. The method of claim 3 wherein:
the interface signals include an interface clock signal characterized by interface clock cycles; and
comparing the response interface signals further comprises comparing, on each interface clock cycle, the response interface signals generated by the hardware device and the exported, recorded simulated response interface signals from the simulated hardware device.

5. The method of claim 1 wherein recording interface signals further comprises recording delay data for each interface signal, the delay data further comprising a representation of a temporal duration for each value of each interface signal.

6. The method of claim 1 further comprising:
setting the simulated hardware device to an initial internal state; and
setting the hardware device to the same initial internal state.

7. The method of claim 1 wherein playing the exported, recorded simulated stimulus interface signals further comprises:
identifying a simulated stimulus transition that occurs one simulated DUT clock cycle after a first simulated active clock transition;
in a first playback of the exported, recorded simulated stimulus interface signals, playing the simulated stimulus transition at a hardware active clock transition corresponding to the first simulated active clock transition; and
in a second playback of the exported, recorded simulated stimulus interface signals, playing the simulated stimulus transition at a hardware active clock transition corresponding to the next simulated active clock transition.

8. An apparatus for verifying a simulated hardware environment for a simulated device under test (‘DUT’), the apparatus comprising at least one computer processor, at least one computer memory operatively coupled to the computer processor, and, disposed within the computer memory, computer program instructions capable of:
recording, in a software domain, interface signals between the simulated DUT and a simulated hardware device of the simulated hardware environment, the interface signals further comprising simulated stimulus interface signals and simulated response interface signals;
exporting, from the software domain to a playback device of a hardware domain, the recorded interface signals, including the simulated stimulus interface signals and the simulated response interface signals; and
playing the exported, recorded simulated stimulus interface signals in the hardware domain from the playback device to the hardware device.

9. The apparatus of claim 8 wherein the hardware device in the hardware domain further comprises an actual hardware part operating under actual conditions of voltage, frequency, and temperature.

10. The apparatus of claim 8 further comprising computer program instructions capable of:
responsive to the playing of the exported, recorded simulated stimulus signals to the hardware device, generating by the hardware device response interface signals from the hardware device to the playback device; and
comparing, by the playback device, the response interface signals generated by the hardware device and the exported, recorded simulated response interface signals from the simulated hardware device.

11. The apparatus of claim 10 wherein:
the interface signals include an interface clock signal characterized by interface clock cycles; and
comparing the response interface signals further comprises comparing, on each interface clock cycle, the response interface signals generated by the hardware device and the exported, recorded simulated response interface signals from the simulated hardware device.

12. The apparatus of claim 8 wherein recording interface signals further comprises recording delay data for each interface signal, the delay data further comprising a representation of a temporal duration for each value of each interface signal.

13. The apparatus of claim 8 wherein playing the exported, recorded simulated stimulus interface signals further comprises:
identifying a simulated stimulus transition that occurs one simulated DUT clock cycle after a first simulated active clock transition;
in a first playback of the exported, recorded simulated stimulus interface signals, playing the simulated stimulus transition at a hardware active clock transition corresponding to the first simulated active clock transition; and
in a second playback of the exported, recorded simulated stimulus interface signals, playing the simulated stimulus transition at a hardware active clock transition corresponding to the next simulated active clock transition.

14. A computer program product for verifying a simulated hardware environment for a simulated device under test (‘DUT’), the computer program product disposed upon a signal bearing medium, the computer program product comprising computer program instruction for:
recording, in a software domain, interface signals between the simulated DUT and a simulated hardware device of the simulated hardware environment, the interface signals further comprising simulated stimulus interface signals and simulated response interface signals;
exporting, from the software domain to a playback device of a hardware domain, the recorded interface signals, including the simulated stimulus interface signals and the simulated response interface signals; and
playing the exported, recorded simulated stimulus interface signals in the hardware domain from the playback device to the hardware device.

15. The computer program product of claim 14 wherein the signal bearing medium comprises a recordable medium.

16. The computer program product of claim 14 wherein the signal bearing medium comprises a transmission medium.

17. The computer program product of claim 14 further comprising computer program instruction for:
responsive to the playing of the exported, recorded simulated stimulus signals to the hardware device, generating by the hardware device response interface signals from the hardware device to the playback device; and
comparing, by the playback device, the response interface signals generated by the hardware device and the exported, recorded simulated response interface signals from the simulated hardware device.

18. The computer program product of claim 17 wherein:
the interface signals include an interface clock signal characterized by interface clock cycles; and
comparing the response interface signals further comprises comparing, on each interface clock cycle, the response interface signals generated by the hardware device and the exported, recorded simulated response interface signals from the simulated hardware device.

19. The computer program product of claim 14 wherein recording interface signals further comprises recording delay data for each interface signal, the delay data further comprising a representation of a temporal duration for each value of each interface signal.

20. The computer program product of claim 14 wherein playing the exported, recorded simulated stimulus interface signals further comprises:
identifying a simulated stimulus transition that occurs one simulated DUT clock cycle after a first simulated active clock transition;
in a first playback of the exported, recorded simulated stimulus interface signals, playing the simulated stimulus transition at a hardware active clock transition corresponding to the first simulated active clock transition; and
in a second playback of the exported, recorded simulated stimulus interface signals, playing the simulated stimulus transition at a hardware active clock transition corresponding to the next simulated active clock transition.
